(19) United States
(12) Patent Application Publication
(10) Pub. No.: US 2016/0141911 A1
(43) Pub. Date: May 19, 2016

(54) OFFSHORE POWER GENERATION SYSTEM

(71) Applicant: KING FAHD UNIVERSITY OF PETROLEUM AND MINERALS, Dhahran (SA)

(72) Inventor: AHMED Z. AL-GARNI, DHAHRAN (SA)

(21) Appl. No.: 14/542,451

(22) Filed: Nov. 14, 2014

(51) Int. Cl. H02J 7/35; H02J 7/00

(52) U.S. Cl. CPC H02J 7/35; H02J 7/0068

(57) ABSTRACT

The offshore power generation system includes a buoyant float for offshore operation. A solar subsystem and a wind subsystem are mounted to the top of the float to harness solar and wind energies and convert the same into useful power, e.g., electricity. A water turbine subsystem and a hydrofoil subsystem are mounted to the bottom of the float to harness tide-wave energies and convert the same into useful power. The generated power from the various subsystems feeds into a rechargeable battery for power collection and distribution.

### BACKGROUND OF THE INVENTION

1. Field of the Invention

The present invention relates to power generators, and particularly to an offshore power generation system that utilizes the forces of renewable resources from the natural environment to produce power for ultimate use and distribution.

2. Description of the Related Art

Alternative or renewable energy is a worldwide concern in the current market mainly due to dwindling resources, lack of infrastructure for some locales, and/or lack of financial resources to build and support production and distribution. Power, such as electricity, and the usage thereof have been increasing annually, and the supplies of conventional resources, such as oil and coal, have been consumed at rates indicating an increased demand. Use of these conventional resources can also tend to impact the environment, such as from the wastes produced during power production. Nuclear power plants are another form of conventional energy production, However, production of nuclear power can also have similar environmental issues as in the energy production using oil and coal, such as the generation and need for proper disposal of potentially harmful wastes from the radioactive materials.

The above are some examples of the factors that can drive increased costs in energy production to both the producers and the consumers. Many alternative or renewable energy production systems have been developed to help in addressing current energy demand, as well as to also provide a potential replacement for or to reduce a need for the more conventional oil or coal-based power plants for energy generation. These alternative energy systems typically harness the energy from the natural environment, such as wind, solar, and water, and convert the natural energy to usable energy, e.g. electricity.

Most of these alternative energy production systems are typically a standalone or a singular type of power generation system. In other words, a typical alternative energy power plant is dedicated to utilizing one alternative or renewable energy resource. Some examples include solar power energy plants utilizing a plurality of solar panel arrays or mirrors, wind power energy plants utilizing a plurality of wind turbines, or hydroelectric power plants utilizing energy from water flow, such as from a dammed body of water, to power turbines.

While the above alternative energy production systems are effective in contributing at varying degrees to the production of energy, such as can be provided to the overall power grid, there does not appear to be an energy generation system that attempts to utilize a multitude of naturally available alternative energy sources, such as water, wind and sunlight, for power production. Thus, an offshore power generation system addressing the aforementioned problems is desired.

### SUMMARY OF THE INVENTION

Embodiments of an offshore power generation system include a buoyant float for offshore operation. A solar subsystem and a wind subsystem are mounted to the top of the float to harness solar and wind energies and convert the same into useful power, e.g., electricity. A water turbine subsystem and a hydrofoil subsystem are mounted to the bottom of the float to harness tide-wave energies and convert the same into useful power. The generated power from the various subsystems feeds into a rechargeable battery for power collection and distribution.

These and other features of the present invention will become readily apparent upon further review of the following specification and drawings.

### BRIEF DESCRIPTION OF THE DRAWINGS

FIG. 1 is an environmental, perspective view of an embodiment of an offshore power generation system according to the present invention.

FIG. 2 is a perspective view of an embodiment of a vertical-axis wind turbine of the offshore power generation system shown in FIG. 1.

FIG. 3 is a perspective sectional view of an embodiment of a water turbine subsystem in the offshore power generation system shown in FIG. 1.

FIG. 4 is a perspective view of an embodiment of a hydrofoil subsystem in the offshore power generation system shown in FIG. 1 with other subsystems of an embodiment of the offshore power generation system removed for clarity.

FIG. 5 is a block diagram of power generation in the offshore power generation system shown in FIG. 1 with the combined power generation subsystems contributing to the overall power production.

Unless otherwise indicated, similar reference characters denote corresponding features consistently throughout the attached drawings.

### DETAILED DESCRIPTION OF THE PREFERRED EMBODIMENTS

The offshore power generation system, generally referred to by the reference number 10 in the drawings, facilitates power production or generation by utilizing various different energies and forces contained in the natural environment to thereby maximize the potential from natural renewable resources. Statistically, about 70% or more of the earth's surface is covered by water. Relatively large bodies of water, such as the seas, lakes, and rivers, are also exposed to the natural environment and subject to effects from the sun, winds, and underwater currents. These types of water bodies provide the natural environment for the offshore power generation system 10. As such, the offshore power generation system 10 includes a buoyant base or float 12, a solar subsystem 20 coupled to a top 12a of the buoyant float 12, a wind subsystem 30 coupled to the top 12a of the float 12, a water turbine subsystem 40 coupled to a bottom 12b of the float 12, and a hydrofoil subsystem 50 coupled to the bottom 12b of the float 12.

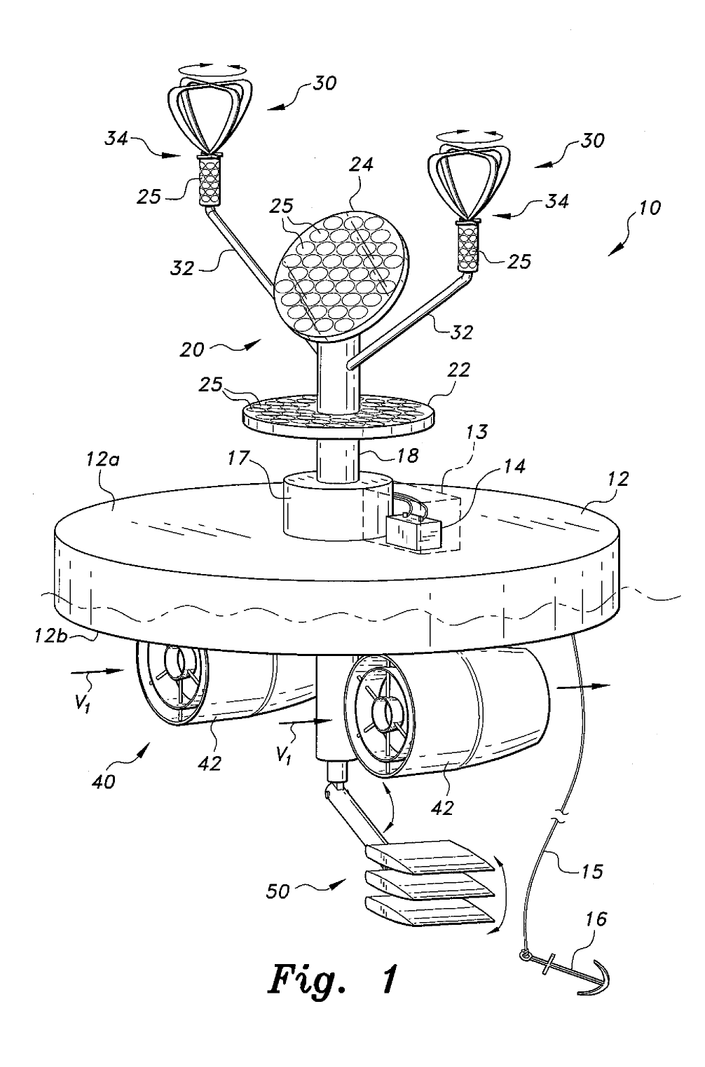

The float 12 provides a generally centralized platform for attaching or mounting all the subsystems 20, 30, 40 and 50 and collection of power generated by the subsystems. As best seen in FIG. 1, the float 12 can be a generally cylindrical-shaped body constructed from buoyant materials, such as foam, plastic, wood, and the like, as is known in the art. The float 12 is desirably provided with a generally flat top 12a and a generally flat bottom 12b for relative ease of construction and attachment of components, for example. Other suitable shapes such as rectangular, ellipsoid and various geometric shapes can be used to form the float 12, as can depend on the use or application, and should not be construed in a limiting sense.

The float 12 can be provided as a substantially solid structure or a substantially hollow structure. The substantially solid-type structure can be suitable for most use scenarios where the floating stability of the offshore power generation system 10 is not a substantial concern. In the case of the substantially hollow structure, the float 12 can be selectively and partially filled with filler material, such as water, sand, and the like, to function as ballast as can enhance stability of the float 12. When so constructed, the float 12 will be partially submerged in the water, more so than without the added weight of the filler or ballast material, to enhance increasing the floating stability of the offshore power generation system 10 on the water. During use, the float 12 is typically substantially fixed at a predetermined or designated relative position on the body of water by an anchor 16 connected to a cable 15 extending from the float 12. The cable 15 can be constructed from chains, sturdy rope, or similar material, for example.

To facilitate collection of power, e.g., electricity, generated by the subsystems 20, 30, 40 and 50, the float 12 includes a power collector, such as in the form of a rechargeable battery 14, disposed inside a collector housing 13. Lines to supply generated power from each of the subsystems 20, 30, 40 and 50 (not shown) are in communication with the battery 14, such as through suitable converter/rectifier circuitry, as known in the art, thereby charging the same. The collector housing 13 is desirably removable or at least be provided with one or more accessible panels or doors to facilitate collection and/or replacement of the battery 14, as well as for maintenance of the battery 14 or of components of the offshore power generation system 10. In an embodiment, a plurality of offshore power generation systems 10 can be placed within a given area of the body of water, and the batteries 14 can be periodically collected and/or replaced so that the collected batteries 14 can be connected to the local power grid or be used individually, for example.

The float 12 also includes a central hub 17 with a post 18 extending upwardly therefrom. The post 18 serves as a mount post for at least one or more of the subsystems for operation above water, such as the solar subsystem 20 and the wind subsystem 30. As shown in FIG. 1, the solar subsystem 20 includes a first solar panel array 22 desirably attached to a middle or lower portion of the post 18 and a second solar panel array 24 desirably attached to the top of the post 18. Each solar panel array 22 and 24 is desirably constructed as a circular disc. However, other shapes such as rectangles, squares, and other geometric shapes can also be used, as can depend on the use or application, and should not be construed in a limiting sense. Moreover, each solar panel array 22 and 24 can be of different dimensions, e.g., the first solar panel array 22 can be larger than the second solar panel array 24 and vice versa. Each solar panel array 22 and 24 also desirably includes a plurality of solar cells 25 mounted thereon. The solar cells 25 absorb heat from the sun's rays and convert the same into power, such as electricity, which is collected by the battery 14.

In an embodiment, it is desirable for one of the solar panel arrays 22 and 24, e.g., first solar panel array 22, be positioned at a first angle, such as horizontal or parallel or substantially horizontal or substantially parallel relative to the top 12a of the float 12 while the other solar panel array, e.g., second solar panel array 24, be positioned at a second angle with respect to the horizontal relative to the top 12a of the float 12, the second angle being different from the first angle. This arrangement of the first solar panel array 22 and the second solar panel array 24 can substantially maximize or enhance exposure of the solar cells 25 of the solar panel arrays 22 and 24 to the sun throughout the day.

For example, the angular disposition of the second solar panel array 24 can be arranged to face the sun during times of about from low horizon to about directly overhead while the horizontal disposition of the first solar panel array 22 faces the sun during the times of about midmorning to midafternoon so as to increase exposure of the solar cells 25 of the solar panel arrays 22 and 24 to the sun throughout the day. Thus, at least some parts of the first solar panel array 22 and the second solar panel array 24 will be exposed to the sun throughout at least a substantial portion of the day and can generate a certain amount of power thereby.

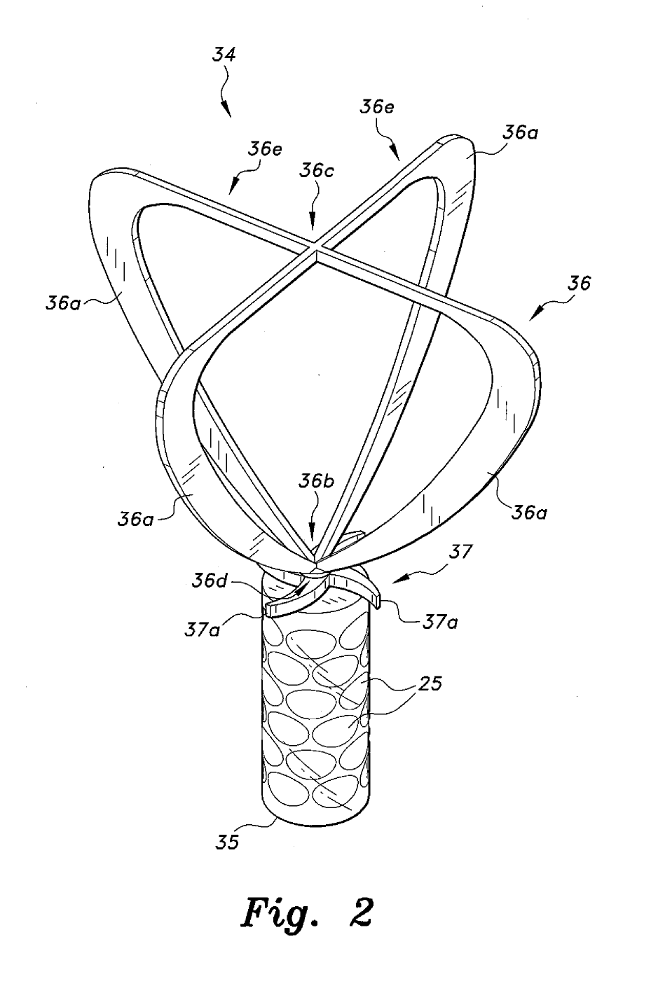

Referring to FIGS. 1 and 2, the wind subsystem 30 includes a pair of arms 32 extending at divergent angles from the post 18, and a vertical-axis wind turbine 34 is mounted to each arm 32. It is contemplated that the arms 32 can extend at various other suitable angles as long as they provide a sufficient separation between the respective vertical-axis wind turbines 34, as can enhance their effectiveness for power generation, for example. Each vertical-axis wind turbine 34 includes a base housing 35 as can include and cover one or more dynamos or generators (not shown), or other suitable power conversion devices, such suitable dynamos, generators or power conversion devices known to those in the art, that convert the motion of the vertical-axis wind turbines 34 to electrical power, and includes a rotor assembly 36 that is rotatably coupled to the base housing 35.

The base housing 35 is desirably cylindrical in shape. However, the shape of the base housing 35 can be varied, such as can be of other suitable shapes or configurations, as can depend on the needs, requirements, and desires of the user. To further enhance maximizing surface area exposure for generation of solar power by the solar subsystem 20, the outer surface of the base housing 35 can be provided with one or more solar cells 25 as a part of the overall solar subsystem 20, for example.

The rotor assembly 36 includes a plurality of rotor blades 36a and a stabilizer assembly, such as a stabilizer rotor 37, disposed at a bottom end 36b of the rotor blades 36a. Each rotor blade 36a is desirably of a generally curvilinear triangle shape or configuration with opposite ends converging at the vertical axis or the axis of rotation of the rotor assembly 36, although other suitable shapes and configurations can be used, as can depend on ₜhe use or application, and should not be construed in a limiting sense. The shape of the rotor blades 36a combined forms an inverted, substantially conical shape or configuration where the bottom end 36b is an apex 36d of the generally conical shape and a top end 36c is a base 36e of the generally conical shape or configuration of the rotor blades 36a.

Each rotor blade 36a is desirably constructed as a relatively thin and flat strip of material formed into the generally curvilinear triangle shape or configuration as shown in FIGS. 1 and 2. It is also contemplated that at least one of the rotor blades 36a can be curved along the length so as to from a generally corkscrew or wavy shape. Whatever the shape, each rotor blade 36a is desirably constructed to provide a suitable surface area to facilitate rotation about the vertical axis of the rotor assembly 36 in reaction to the wind passing through the rotor blades 36a. In an embodiment, each vertical-axis wind turbine 34 is desirably provided with four rotor blades 36a. The number of blades, such as the four rotor blades 36a, has been found to be highly efficient as a result of tradeoffs between factors such as power drawn from each blade and the interference effect of each blade on another, for example.

In an embodiment, the rotor assembly 36 typically does not include a central, vertical shaft that extends between the ends of the rotor blades 36a. Such a shaft can potentially increase drag on the wind passing through the rotor blades 36a and diminish the potential energy. However, the rotor assembly 36 can be provided with such a shaft to increase structural stability as required.

As best seen in FIG. 2, the stabilizer assembly, such as the stabilizer rotor 37, associated with the rotor assembly 36 desirably includes a plurality of radiating stabilizer blades 37a. The stabilizer blades 37a are desirably curved to enhance capture of the wind and be rotated thereby. The stabilizer rotor 37 assists in stabilizing the gyroscopic effect as can typically result from rotation of the rotor blades 36a.

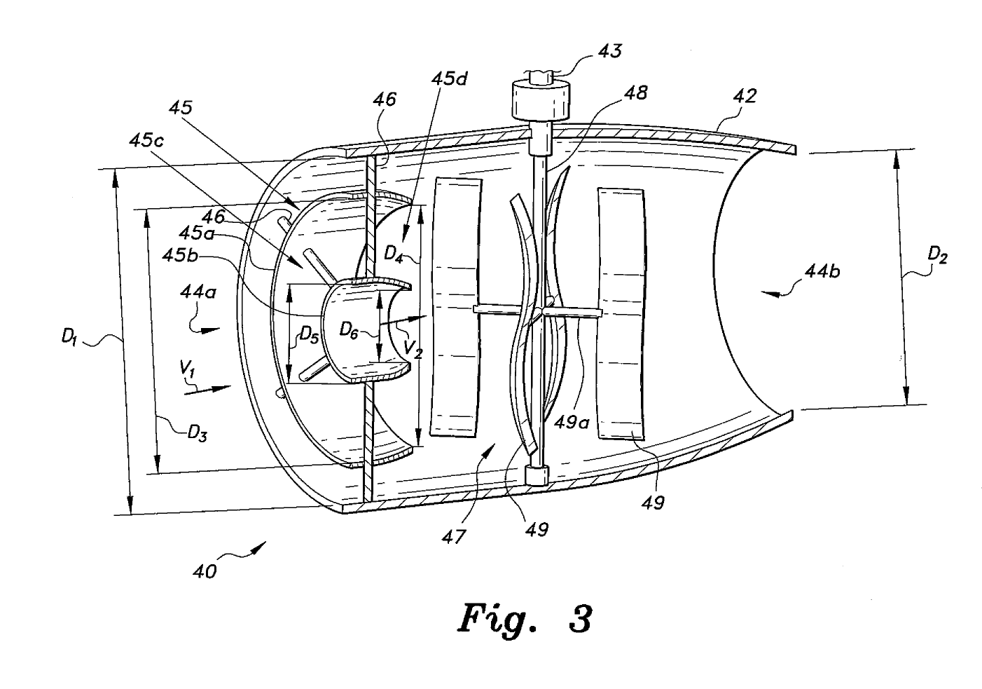

While the solar subsystem 20 and the wind subsystem 30 employ the natural environment energies above the surface of the body of water to produce power, the offshore power generation system 10 includes at least two separate subsystems that exploit the environmental energies underwater, e.g., underwater current, velocity, and the motion thereof collectively construed as tide-wave energy. One of the underwater subsystems is the water turbine subsystem 40 shown in FIGS. 1 and 3.

The water turbine subsystem 40 is coupled to the bottom 12b of the float 12. The water turbine subsystem 40 includes one or more venturi pods 42 rotatably coupled to the bottom 12b of the float 12, such as by being mounted to a support shaft, beam, or bar 43 extending downwardly from the bottom 12b of the float 12. Each venturi pod 42 is desirably free to rotate about the support shaft 43 so as to facilitate self-adjustable repositioning of the venturi pod 42, such as in response to course changes in the underwater current. The mounting of the venturi pods 42 can also be fixed in conditions where the underwater current is suitably strong enough to orient the venturi pods 42 so that the water flows through the venturi pods 42.

Each venturi pod 42 is desirably generally ovoid in shape forming a generally hollow housing with an inlet 44a at one end and an outlet 44b at the opposite end, the inlet 44a desirably having a diameter or opening D₁ larger than the diameter or opening D₂ of the outlet 44b, the different opening dimensions can assist in compressing the water as the water travels from the inlet 44a to the outlet 44b to thereby increase the given velocity of the incoming water. The ovoid shape is desirable in that it is relatively more hydrodynamic and increases the work efficiency of the water passing through venturi pod 42. However, other shapes, such as cylindrical, oblong, and the like, can be employed depending on the needs and desires of the user, and the shape or configuration of the venturi pod 42 should not be construed in a limiting sense.

Also, each venturi pod 42 operates in a similar manner to wind turbines and employs water current and the velocity thereof to drive internal components for generating power. As best seen in FIG. 3, each venturi pod 42 includes a compressor 45 supported by one or more support rods 46 at the inlet 44a and includes a vertical-axis water turbine 47 mounted within the venturi pod 42, such as being rotatably coupled to the support shaft 43, for example.

The compressor 45 serves as a passive structure that increases an incoming velocity v₁ of the water current, as a given velocity, to a higher exit velocity v₂ than the given velocity v₁ for the water current to impart as much momentum to the vertical-axis water turbine 47 as possible. Similar to the shape of the venturi pod 42, the compressor 45 desirably includes one or more annular bushings, such as annular bushings 45a and 45b, of a generally ovoid shape so that an inlet opening 45c of the compressor 45 is of larger dimensions than the dimensions of an outlet opening 45d, although other suitable shapes can be used, as can depend on the use or application, and should not be construed in a limiting sense.

For example, the compressor 45 includes the inlet or inlet opening 45c having a given opening dimension D₃ for an outer bushing 45a and a given opening dimension D₅ for an inner bushing 45b. The compressor 45 includes the outlet or outlet opening 45d having a given opening dimension D₄ for the outer bushing 45a and a given opening dimension D₆ for the inner bushing 45b, the opening dimension D₄ being smaller than the opening dimension D₃ for the outer bushing 45a and the opening dimension D₆ being smaller than the opening dimension D₅ for the inner bushing 45b, for example.

The different opening dimensions D₃, D₄, D₅, and D₆ compress the water as the water travels from the inlet 45c to the outlet 45d to thereby increase the given velocity of the incoming water. As the water passes through the inlet of the compressor 45, the internal dimensions of the compressor 45 gradually decrease in much the same manner as a nozzle or a funnel so as to compress the mass of the water and forcibly eject the water through the outlet at a higher exit velocity v₂ than the incoming velocity v₁. The exit velocity v₂ of the water drives the vertical-axis water turbine 47.

In an embodiment, the compressor 45 is desirably constructed from a fabric coated with microspheres containing PCM (paraffinic hydrocarbons), a surfactant, a dispersant, anti-foam and a thickener. The fabric construction facilitates a degree of self-adjustment to accommodate various water current conditions during use by deformation. The coating of the fabric also substantially reduces the tendency of the water to adhere to surfaces of the compressor 45 so as to minimize energy loss from the water being directed towards the vertical-axis turbine 47. Additionally, the coating assists in removing some heat from the water passing through the compressor 45 thereby reducing its temperature and increasing its velocity. The compressor 45 can also be constructed from more rigid materials with a similar coating mentioned above and the type and composition of materials forming the compressor 45 should not be construed in a limiting sense. Also, the compressor 45 can be an adjustable structure so as to adjust a by-pass ratio of the water that is by-passed through the inlet 45c of the compressor 45, as can depend on the type of flow for the water, for example. Such adjustment of the by-pass ratio of the water can be made by adjusting the position, size and/or number of by-pass structures, such as the annular bushings 45a and 45b, for example.

The vertical-axis water turbine 47 is rotatably mounted within the venturi pod 42 downstream of the compressor 45, the higher exit velocity v₂ driving the vertical-axis water turbine 47. The vertical-axis water turbine 47 includes a vertically oriented shaft 48 coupled to the venturi pod 42, such as by being coupled to the support shaft 43. The vertically oriented shaft 48 is rotatable with respect to the venturi pod 42. A plurality of vertical impellers 49 are mounted to corresponding spokes 49a radiating from shaft 48. The higher exit velocity v₂ of the water exiting from the compressor 45 acts on the vertical impellers 49 causing the same to rotate the shaft 48 about the vertical axis of the shaft 48.

The shaft 48 is operatively coupled to a generator or other suitable power conversion device (not shown), such suitable dynamos, generators or power conversion devices known to those in the art, which converts the rotation of the impellers 49 into power, such as electricity. The higher exit velocity v₂ of the water from the compressor 45 acts on the vertical impellers 49 to rotate the vertically oriented shaft 48 and thereby generate power. The generator or other suitable power conversion device associated with the water turbine subsystem 40 can be positioned at a suitable location on the offshore power generation system 10. The generated power from the water turbine subsystem 40 feeds into the battery 14 to charge the same, as described.

Each impeller 49 of the water turbine subsystem 40 is desirably constructed from a relatively thin strip of material formed into a substantially curvilinear, wavy, or sinusoidal shape. The sinusoidal shape for the impeller 49 typically provides a greater surface area for the moving water to act on the impeller 49, such as compared to a generally straight impeller of the same height, and thereby can maximize a surface area for the water to act on the vertical impeller 49 for a given height of the vertical impeller 49. Additionally, at least the upper and lower ends of each impeller 49 can be tapered to reduce the relative mass and weight of the impeller 49. The reduced mass and weight desirably typically equates to less force required to move the respective impellers 49 as can thereby increase the efficiency of the vertical-axis water turbine 47.

It is noted that the outlet 44b of the venturi pod 42 should not be too small relative to the inlet 44a due to potential back pressure that can occur at the outlet 44b as a result of a much constricted outlet opening. Such a phenomenon can impede rotation of the impellers 49 and can thereby reduce power generation.

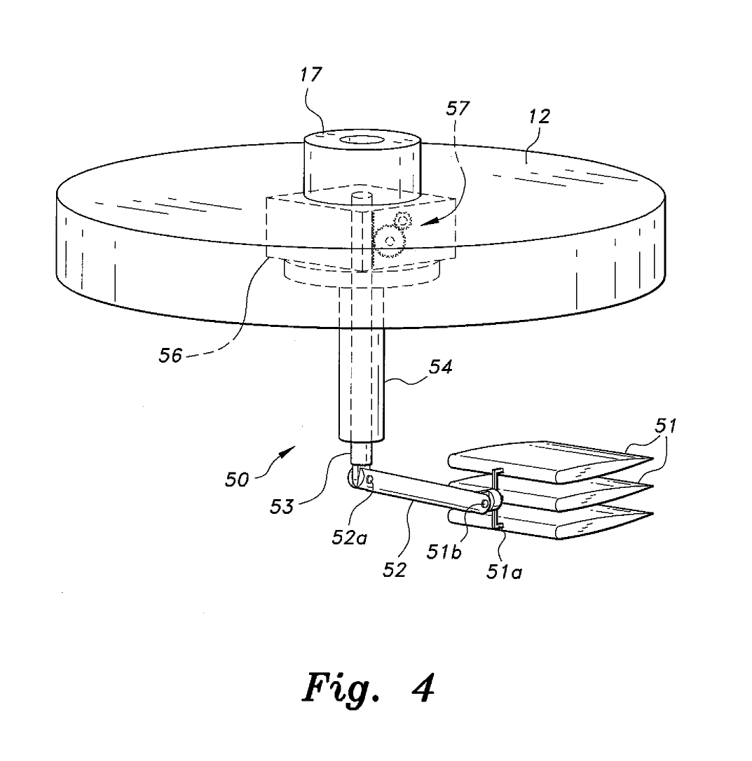

Another of the underwater subsystems is the hydrofoil subsystem 50 shown in FIGS. 1 and 4. The hydrofoil subsystem 50 includes one or more hydrofoils 51 pivotably coupled to an articulating first arm 52 at one end of the articulating first arm 52, which in turn is pivotably coupled to a second arm 53 at an opposite end of the articulating first arm 52. Each hydrofoil 51 is desirably a wing or wing blade constructed to ride the water currents and/or waves and the undulations thereof. A plurality of hydrofoils 51 can be mounted to a bracket 51a, and the bracket 51a is pivotable about a pivot 51b at one end of the first arm 52. It has been found that three hydrofoils 51, similar to the wings of a tri-plane, can enhance and provide efficient power generation.

As the hydrofoils 51 ride the natural motion of the underwater current and/or waves and the undulations thereof, the movement of the underwater current and/or waves and the undulations thereof forces the hydrofoils 51 to move up and down and pivot about the pivot 51b following the natural undulations of the current. This reactionary movement of the hydrofoils 51 causes the first arm 52 to pivot about a first arm pivot 52a at the opposite end of the first arm 52, which is connected to the second arm 53.

The second arm 53 is slidably mounted to a hydrofoil support post 54 extending downwardly from the bottom 12b of the float 12. One end of the second arm 53 is pivotably mounted to the first arm 52 at the first arm pivot 52a while the opposite end of the second arm 53 is operatively coupled to a gear box 56 positioned in conjunction with the float 12, such as being positioned inside the float 12. The gear box 56 is operatively coupled to the opposite end of the second arm 53. The pivoting motion of the first arm 52 causes the second arm 53 to reciprocate within the hydrofoil support post 54 in response to up and down movements of one or more of the hydrofoils 51.

The gear box 56 includes a gear arrangement 57, schematically illustrated in FIG. 4, such as rack and pinion, bevel gears, and the like, which converts or transforms the reciprocating movement of the second arm 53 into rotation to drive a generator or other suitable power conversion device associated with the hydrofoil subsystem 50 (not shown) as can be positioned at a suitable location on the offshore power generation system 10 and produce or generate power. The power generated by the hydrofoil subsystem 50 is collected by the battery 14, as described.

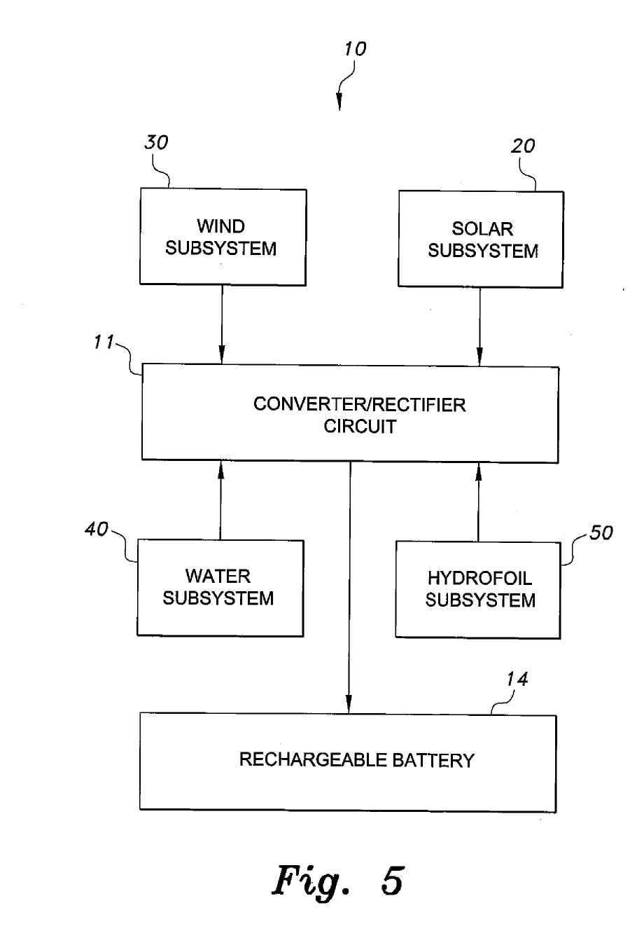

Referring to FIG. 5, the block diagram shows a schematic diagram of the offshore power generation system 10 illustrating how all the subsystems 20, 30, 40 and 50 described above work in combination to produce power. Each subsystem, such as the solar subsystem 20, the wind subsystem 30, the water turbine subsystem 40, and the hydrofoil subsystem 50, is operatively coupled to a converter/rectifier circuit 11, such as suitable converter/rectifier circuitry, as known in the art, which converts, rectifies, and transmits the generated power from each subsystem to the rechargeable battery 14 or other suitable power collector, for example, for collection and distribution, and the generated power from the offshore power generation system 10 can also be provided to or operatively connected to a power collector for collection and distribution to other suitable power collection devices, such as for transmission over a power grid.

Thus, it can be seen that the offshore power generation system 10 employs a plurality of energy collection subsystems, such as the subsystems 20, 30, 40 and 50 that utilize common renewable energy resources from the natural environment to produce power. This results in a relatively compact power plant with minimal negative impact to the environment. Additionally, the offshore power generation system 10 can operate throughout a substantial portion of the day with no significant downtime apart from maintenance requirements.

It is to be understood that the present invention is not limited to the embodiments described above, but encompasses any and all embodiments within the scope of the following claims.

I claim:

1. An offshore power generation system, comprising:
a buoyant float adapted to float on a body of water, the float having a top and a bottom;
a power collector operatively coupled to the buoyant float to receive generated power;
a solar subsystem coupled to the top of the float, the solar subsystem generating power by using solar energy;
a wind subsystem coupled to the top of the float, the wind subsystem generating power by using wind energy;
a water turbine subsystem coupled to the bottom of the float, the water turbine subsystem generating power by using a water current of the body of water, the water current having a velocity; and
a hydrofoil subsystem coupled to the bottom of the float, the hydrofoil subsystem generating power by using at least one of the water current and a wave motion of the body of water,
wherein the power generated by the solar subsystem, the wind subsystem, water turbine subsystem and the hydrofoil subsystem feeds into the power collector for storage and subsequent distribution.

2. The offshore power generation system according to claim 1, wherein the power collector comprises a rechargeable battery.

3. The offshore power generation system according to claim 1, further comprising:
a cable extending from the float; and
an anchor attached to an end of the cable, the anchor substantially fixing a relative position of the float on the body of water.

4. The offshore power generation system according to claim 1, wherein the float comprises:
a central hub; and
a post extending upwardly from the central hub.

5. The offshore power generation system according to claim 4, wherein the solar subsystem comprises:
a first solar panel array mounted to the post, the first solar panel array having at least one solar cell; and
a second solar panel array mounted on top of the post above the first solar panel array, the second solar panel array having at least one solar cell,
wherein the first solar panel array and the second solar panel array convert solar energy into power to be collected by the power collector.

6. The offshore power generation system according to claim 5, wherein
the first solar panel array is positioned at a first angle with respect to the top of the buoyant float, and
the second solar panel array is positioned at a second angle with respect to the top of the buoyant float, the second angle being different from the first angle.

7. The offshore power generation system according to claim 4, wherein the wind subsystem comprises:
at least one arm extending from the post; and
at least one vertical-axis wind turbine respectively mounted to a corresponding arm.

8. The offshore power generation system according to claim 7, wherein the at least one vertical-axis wind turbine comprises:
a base housing respectively coupled to a corresponding arm; and
a rotor assembly rotatably mounted to the base housing.

9. The offshore power generation system according to claim 8, further comprising:
at least one solar cell mounted to the base housing to increase solar exposure area for generation of solar power by the solar subsystem.

10. The offshore power generation system according to claim 8, wherein the rotor assembly comprises:
a plurality of rotor blades extending vertically from the base housing, the rotor blades rotating with respect to the base housing in response to wind passing through the rotor blades, each rotor blade having a substantially curvilinear triangle shape, the rotor blades combined forming a substantially inverted cone with an apex of the cone disposed at a bottom end of the rotor blades and a base of the cone disposed at a top end of the rotor blades; and
a stabilizer assembly coupled to the bottom end of the rotor blades to stabilize gyroscopic effects of the rotor blades during rotation thereof.

11. The offshore power generation system according to claim 1, wherein the water turbine subsystem comprises:
at least one support shaft coupled to the bottom of the float;
at least one venturi pod coupled to the support shaft, the venturi pod having an inlet and an outlet;
at least one support rod;
a compressor disposed at the inlet of each venturi pod, the compressor being supported by the at least one support rod, the compressor adapted to increase a given velocity of incoming water to a higher exit velocity than the given velocity; and
a vertical-axis water turbine rotatably mounted within the venturi pod downstream of the compressor, the higher exit velocity of the water driving the vertical-axis water turbine.

12. The offshore power generation system according to claim 11, wherein the compressor comprises:
an inlet having at least one given opening dimension; and
an outlet having at least one an opening dimension respectively smaller than a corresponding given opening dimension of the inlet,
wherein the different opening dimensions compress the water as the water travels from the inlet to the outlet of the compressor to thereby increase the given velocity of the incoming water.

13. The offshore power generation system according to claim 12, wherein the compressor is constructed from fabric having a coating thereon, the coating having microspheres containing at least paraffinic hydrocarbons, a surfactant, a dispersant, anti-foam and a thickener to substantially reduce adherence of the water and cool the water as the water passes through the compressor.

14. The offshore power generation system according to claim 11, wherein the vertical-axis water turbine comprises:
a vertically oriented shaft coupled to the support shaft, the vertically oriented shaft being rotatable with respect to the support shaft, the vertically oriented shaft having a plurality of spokes radiating therefrom; and
a plurality of vertical impellers mounted to corresponding spokes, the higher exit velocity of the water from the compressor acting on the vertical impellers to rotate the vertically oriented shaft and thereby generate power.

15. The offshore power generation system according to claim 14, wherein each vertical impeller comprises:
a relatively thin strip of material formed into a substantially curvilinear shape to maximize a surface area for the water to act on the vertical impeller for a given height of the vertical impeller.

16. The offshore power generation system according to claim 15, wherein each vertical impeller further comprises:
tapered ends to reduce a mass and a weight of the vertical impeller.

17. The offshore power generation system according to claim 1, wherein the hydrofoil subsystem comprises:
a hydrofoil support post extending downwardly from the bottom of the float;
at least one hydrofoil adapted to ride one or more of undulations of the water current and waves thereby forcing up and down movements of the at least one hydrofoil;
a first arm pivotably coupled to the at least one hydrofoil at one end;
a second arm slidably mounted to the hydrofoil support post and reciprocable therein, one end of the second arm being pivotably coupled to the first arm at the opposite end of the first arm; and
a gear box disposed in conjunction with the float, the gear box being operatively coupled to the opposite end of the second arm, the second arm reciprocating within the hydrofoil support post in response to up and down movements of the at least one hydrofoil, the gear box having a gear arrangement converting the reciprocation of the second arm to rotation for generating power.

18. An offshore power generation system, comprising:
a buoyant float adapted to float on a body of water, the float having a top and a bottom;
a power collector operatively coupled to the buoyant float to receive generated power; and
a plurality of subsystems operatively connected to the buoyant float to generate power to be collected by the power collector, the plurality of subsystems using natural energy sources to generate power,
wherein one of the plurality of subsystems comprises a wind subsystem coupled to the top of the float, the wind subsystem generating power by using wind energy, the wind subsystem including at least one vertical-axis wind turbine, the at least one vertical axis wind turbine including a base housing and a rotor assembly rotatably mounted to the base housing, a plurality of rotor blades extending vertically from the base housing, the rotor blades rotating with respect to the base housing in response to wind passing through the rotor blades, each rotor blade having a substantially curvilinear triangle shape, the rotor blades combined forming a substantially inverted cone with an apex of the cone disposed at a bottom end of the rotor blades and a base of the cone disposed at a top end of the rotor blades, and a stabilizer assembly coupled to the bottom end of the rotor blades to stabilize gyroscopic effects of the rotor blades during rotation thereof.

19. An offshore power generation system, comprising:
a buoyant float adapted to float on a body of water, the float having a top and a bottom;
a power collector operatively coupled to the buoyant float to receive generated power; and
a plurality of subsystems operatively connected to the buoyant float to generate power to be collected by the power collector, the subsystems using natural energy sources to generate power,
wherein one of the plurality of subsystems comprises a water turbine subsystem coupled to the bottom of the float, the water turbine subsystem generating power by using a water current of the body of water, the water turbine subsystem comprising:
at least one venturi pod coupled to the float, the venturi pod having an inlet and an outlet;
at least one support rod;
a compressor disposed at the inlet of each venturi pod, the compressor being supported by the at least one support rod, the compressor adapted to increase a given velocity of incoming water to a higher exit velocity than the given velocity;
a vertical-axis water turbine rotatably mounted within the venturi pod downstream of the compressor, the higher exit velocity of the water driving the vertical-axis water turbine;
a vertically oriented shaft coupled to the venturi pod, the vertically oriented shaft being rotatable with respect to the venturi pod, the vertically oriented shaft having a plurality of spokes radiating therefrom; and
a plurality of vertical impellers mounted to corresponding spokes, the higher exit velocity of the water from the compressor acting on the vertical impellers to rotate the vertically oriented shaft and thereby generate power.

20. The offshore power generation system according to claim 19, wherein the compressor is constructed from fabric having a coating thereon, the coating having micro spheres containing at least paraffinic hydrocarbons, a surfactant, a dispersant, anti-foam and a thickener to substantially reduce adherence of the water and cool the water as the water passes through the compressor.
